(19) United States
(12) Patent Application Publication
(10) Pub. No.: US 2014/0331140 A1
(43) Pub. Date: Nov. 6, 2014

(54) METHOD AND SYSTEM FOR MANAGING DATA

(71) Applicant: Daniel Julius MAXWELL, (US)

(72) Inventor: Daniel Julius Maxwell, Exeter (GB)

(21) Appl. No.: 14/361,388

(22) PCT Filed: Dec. 5, 2012
(86) PCT No.: PCT/GB2012/000888

§ 371 Date: May 29, 2014

(30) Foreign Application Priority Data
Dec. 5, 2011 (GB) 1120877.4

(51) Int. Cl. G06F 3/0484

(52) U.S. Cl. CPC G06F 3/0484
USPC 715/734

(57) ABSTRACT

The present invention relates to a method and system for managing data. A computer-implemented method of managing data is disclosed. The method includes the steps of defining a plurality of nodes, at least some of the node including different data structures; defining connections between each of the nodes to one or more of the other nodes to form a network of nodes and a data and function flow within the network, wherein each connection defines an output from one node and an input to at least one other node; defining data within at least some of the nodes in accordance with their data structure; defining a function for at least one node of the plurality of nodes, wherein the function defines a processing mechanism for data from one or more of the nodes connected to the one node or for data to one or more of the nodes connected to the one node; and processing the data within the network of nodes in accordance with the connections and functions within the network of nodes.

### FIELD OF INVENTION

The present invention is in the field of managing data. In particular, but not exclusively, the present invention relates to a method and system for managing, visualising, manipulating and processing data.

### BACKGROUND

It is often useful to be able to interact with digital information to process the information to produce outcomes.

There are numerous computer science paradigms for manipulating digital information, or data. For example, spreadsheets provide for the manipulation of numeric data and databases provide for the manipulation of related tables of data.

However, existing paradigms have a number of disadvantages. For example, it can be difficult to structure complex relationships between data within spreadsheets, and it can be difficult for a lay-user to construct an effective and valid database. Programming languages require carefully considered design and knowledge of syntax. In all structures it is difficult to take an overview of the relationships between data and to navigate through them. In all structures it is difficult to share isolated data or data structures with others whilst controlling their access, it is difficult to audit work, and it is difficult to maintain and update data structures.

One database system for the management, visualisation, and manipulation of data is Microsoft Access. Microsoft Access attempts to make databases accessible to unskilled users but is still a database, is difficult to use, inflexible and cannot perform anything other than very simple numerical calculations.

It is an object of the present invention to provide a system for managing data which overcomes the disadvantages of the prior art, or at least provides a useful alternative.

### SUMMARY OF INVENTION

According to a first aspect of the invention there is provided a computer-implemented method of managing data, including:

a) defining a plurality of nodes, at least some of the node including different data structures;
b) defining connections between each of the nodes to one or more of the other nodes to form a network of nodes and a data and function flow within the network, wherein each connection defines an output from one node and an input to at least one other node;
c) defining data within at least some of the nodes in accordance with their data structure;
d) defining a function for at least one node of the plurality of nodes, wherein the function defines a processing mechanism for data from one or more of the nodes connected to the one node or for data to one or more of the nodes connected to the one node; and
e) processing the data within the network of nodes in accordance with the connections and functions within the network of nodes.

One of the nodes may be defined as a group of at least some of the plurality of nodes to form a complex data structure. A complex data structure may be one of a list, a table, or a hypercube.

The data structures may include a literal, a list, a table, and a hypercube.

The plurality of nodes and connections may be defined within a user interface.

The user interface may be a graphical user interface and the nodes and connections may be defined by using graphical entities.

A portion of the network may be grouped together to form a node, the input and output connections to the node corresponding to the input and output connections to and from the portion of the network.

The portion of the network may be grouped together in response to user input via a user interface.

Access control for other users may be defined for the grouped portion by the user.

The access control may include one or more from the set of write-access, read-access, and input and/or output access to the inputs or outputs of each node in the group.

Alternatively, the portion of the network may be grouped together automatically. The portion may be grouped to assist display of the network on a graphical user interface.

The connections to a node may define inputs to the function defined within the node and the connections from a node may define outputs from the function.

The method may further including the step of defining a function within at least one node, wherein the function defines a processing mechanism for data within the nodes connected to the one node.

One of the nodes may be defined as a table or hypercube, this node may specify a list of nodes, and each node within the list provides at least one dimension to the table or hypercube.

A function of a node connected to the table/hypercube node may be defined to generate data for at least one of the dimensions of the table/hypercube.

According to another aspect of the invention there is provided a system for managing data, including:

A user interface configured for defining a plurality of nodes, at least some of the node including different data structures; for defining connections between each of the nodes to one or more of the other nodes to form a network of nodes and a data and function flow within the network, wherein each connection defines an output from one node and an input to at least one other node; for defining data within at least some of the nodes in accordance with their data structure; and for defining a function for at least one node of the plurality of nodes, wherein the function defines a processing mechanism for data from one or more of the nodes connected to the one node or for data to one or more of the nodes connected to the one node; and

A processing component configured for processing the data within the network of nodes in accordance with the connections and functions within the network of nodes.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a system in accordance with an embodiment of the invention;

FIG. 2: shows a block diagram illustrating a hardware infrastructure for a system in accordance with an embodiment of the invention;

FIG. 3: shows a flowchart illustrating a method in accordance with an embodiment of the invention;

FIGS. 4a, 4b, and 4c: show diagrams illustrating the definition of nodes, connections and functions in accordance with an embodiment of the invention;

FIG. 5: shows a diagram illustrating the definition of functions in relation to groups in accordance with an embodiment of the invention;

FIGS. 6a and 6b: show diagrams illustrating the creation of groups in accordance with an embodiment of the invention;

FIG. 7: shows a diagram illustrating the creation of filters/views in accordance with an embodiment of the invention;

FIG. 8: shows a screenshot illustrating the sharing of model fragments in accordance with an embodiment of the invention;

FIGS. 9, 10, and 11: show screenshots illustrating collapsed views in accordance with an embodiment of the invention;

FIG. 12: shows a diagram illustrating multiple view sets in accordance with an embodiment of the invention; and

FIG. 13: shows a block diagram illustrating the data architecture for a system in accordance with an embodiment of the invention.

### DETAILED DESCRIPTION OF PREFERRED EMBODIMENTS

The present invention provides a method and system for managing, visualising and manipulating data.

An embodiment of the system will now be described.

The system provides an interaction layer on top of a data layer. Access to data layer can be shared amongst multiple users. The system solves the problems of synchronicity of data access which exist with current spreadsheet systems, and the problems of data manipulation which exist with current database systems.

The interaction layer provides a mechanism for creating data models. The models contain definitions of data and definition of relationships between input data and output data. The interaction layer provides a user interface to create visual representations of the data models where data and functions and represented within visual nodes, and relationships between the nodes are defined as visual connections.

The data layer can store data in any one of a plurality of ways, such as a database. The data layer provides a mechanism for interfacing between the interaction layer and the stored data.

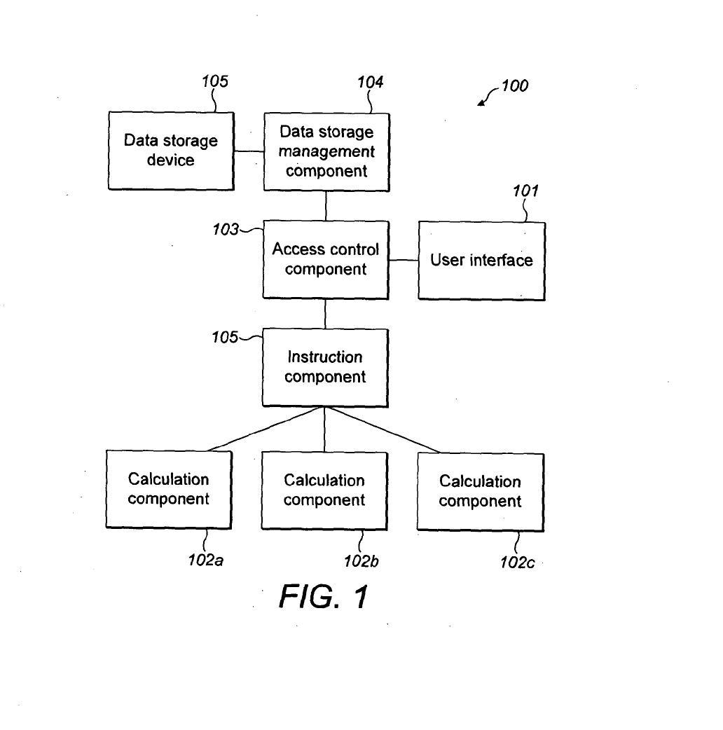

With reference to FIG. 1, a system 100 in accordance with an embodiment of the invention will be described.

A user interface 101 is shown. The user interface 101 is configured to receive input from a user to define nodes within a model. The nodes may be defined visually as graphical entities. Some of the nodes will contain different data structures to the other nodes. Some of the nodes may be grouped together to form differing data structures. For example, the basic node may be literal. Multiple literals may be grouped together to form a list, table or hypercube. A literal data structure may contain a numeric value, string value, a link to an external data source, or a function.

The user interface 101 is further configured to receive input from the user to define connections between the nodes. The connections may be defined visually as graphical entities. The connections connect outputs from nodes to inputs on other nodes. The outputs from nodes may be data stored within the nodes, the data generated from the nodes (due to an executing function), or a function within the node. The connections may be connected to specific inputs within the node. For example, where the node requires an input A and an input B, a connection from a first node may be connected to input A and a connection from a second node may be connected to input B.

The user interface 101 is further configured to receive input from the user to define data within at least some of the nodes.

The user interface 101 is further configured to receive input from the user to define functions within at least some of the nodes. The functions may define a processing mechanism to process data input into the node to generate outputs for the node. The functions may be define within a functional programming language.

The system 100 may thus provide for the definition of a network of nodes containing data and functions, with the connections defining data and function flow through the network.

The system 100 may provide a plurality of calculation components 102a, 102b, 102c to execute the functions within the network. An access control component 103 is shown. The access control component 103 is configured to coordinate access between the user interface 101, a data storage management component 104, and an instruction component 105.

The data storage management component 104 is configured to store and retrieve the nodes, connections, data, and functions within a data storage device 106. The data storage device 106 may be configured to provide a database, such as a relational database. The data storage management component 104 may be configured to map nodes, connections, data, and functions to the relational database.

The instruction component 105 is configured for coordinating execution of the functions with the plurality of calculation components 102. The instruction component 105 may select calculation components based upon the type of function and corresponding type of calculation component 102 (for example, matching programming language of the function to the correct programming language calculation component), and/or it may select calculation components 102 based upon the location of the calculation component 102 or complexity of the function to execute (for example, calculation components 102 located locally may be used for simple calculations and calculation components 102 located on a remote distributed processing network may be used for complex calculations).

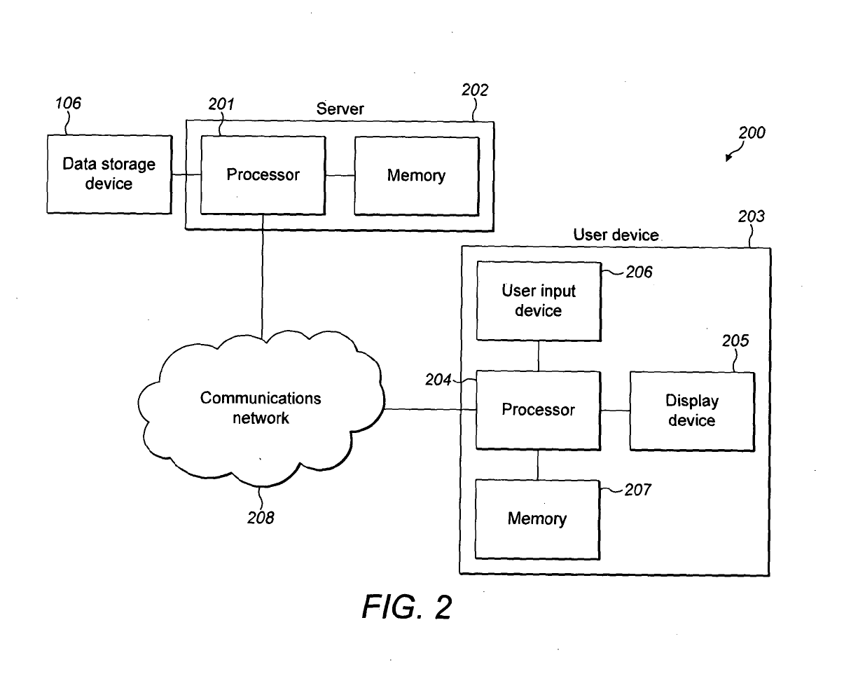

With reference to FIG. 2, the above system will be described when deployed within a hardware infrastructure 200.

A processor 201 at a server 202 may be configured to execute the data storage management component 104. The processor 201 may be connected to the data storage device 106.

The processor 201 at the server 202 may also be configured to execute one or more of the calculation components 102.

A user device 203 is shown with a processor 204, a display device 205, an user input device 206, and a memory 207.

The server 202 may be connected to the user device 203 via a communications network 208 such as a LAN (Local Area Network), intranet, or the Internet.

The processor 204 on the user device 203 may be configured to execute the access control component 103.

The processor 204, display device 205, and user input device 206 on the user device 203 may be configured to provide the user interface 101.

The processor 204 may also be configured to execute the instruction component 105 and one or more of the calculation components 102.

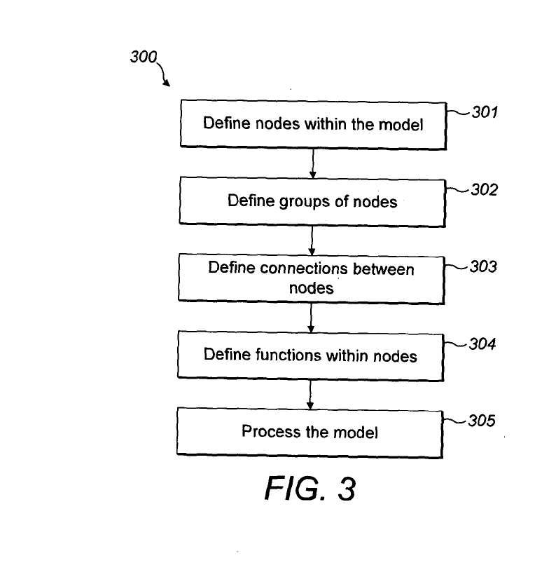

Referring to FIG. 3, a method 300 of managing data will be described.

A data model can be created by a user using the system described in FIG. 1.

In step 301, nodes are defined within the model. The nodes can defined in one of a plurality of data structures. For example, the nodes could be defined as literals (values, functions or links to external sources), as lists, as tables, or as hypercubes. In one embodiment, all complex data structures (lists, tables, and hypercubes) within a node are defined by grouping together multiple nodes in various groupings. For example, to form a list node, a plurality of literal nodes are grouped together, and to form a table node, a plurality of list nodes may be grouped together.

Nodes are grouped in step 302, each grouping of nodes is also a node, that can in turn be grouped together with other nodes.

In step 303, connections between the nodes are defined. The connections specify the inputs to a node and the outputs from a node.

In step 304, functions are defined within some of the nodes. The functions may take inputs from connections from other nodes, and may produce outputs for connection to other nodes.

In step 305, data is defined within some of the nodes.

As a consequence of steps 301 to 305, a network of nodes has been created which includes the definition of data and function flow through the network.

In step 306, the network can be processed to execute functions upon data and result in data flow through the network.

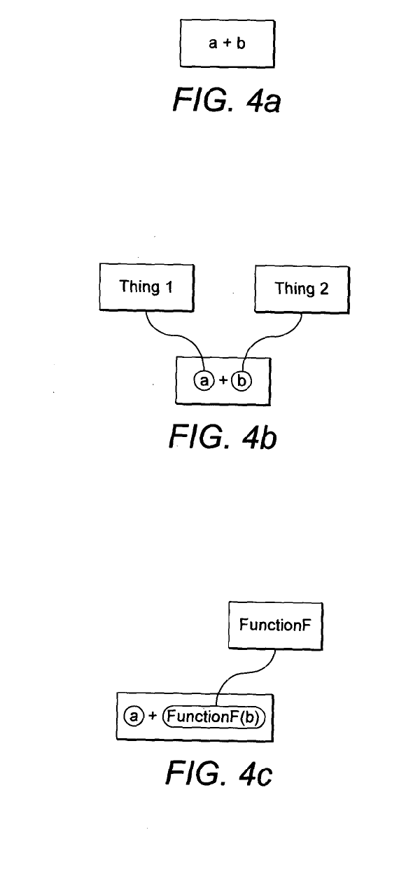

An embodiment of the system will now be described with reference to FIGS. 4a to 13.

### Nodes and Groups

A model consists of nodes connected together, output of one to input of another.

A node is an object containing data of any type (literal, expressions, list, table, URLs, embedded document, or anything else). Within each node there is also a list of its inbound connections (so that it knows where to send requests for updates) and its outbound connections (so that it knows who to tell if it is updated).

A node can contain a connection to an external data source. A request from the external source could trigger the node to update, or the data could be fetched from the external source in response to a user action, or it could be fetched to a schedule. The input collected could pass the latest value into its calculations and outputs or could retain every value it collects as a time-stamped list.

Nodes can be grouped. Each node can only be in one group. A group is also a node. Within each group is a list of nodes. This list has a reference to where the rest of the information about that node can be found.

Any node can be a label(annotation) to any other node.

A model is a type of group which contains its top level groups. A user is a type of group which contains its models and contacts. A central database of top level nodes (such as users) will enable a user to log on and their models to be loaded.

### Lists

Nodes can be contained together in a list.

### Functions

A node can contain a function of arbitrary length and complexity.

Examples are now shown with reference to FIGS. 4a, 4b, 4c:

### Example 1

a+b; is a function of two inputs.
This would be used as follows:
1. A user would type “a+b” into the entry box and it becomes a function containing a node (FIG. 4a). This node has two inputs, a and b. In this state, the output of the function is the entire function. If that output is used as an input to another node, it replicates this function and inputs can be plugged into it within the other node.
2. The user could instead create two other nodes, for example, named “thing1” and “thing2” and connect them to the inputs (FIG. 4b). The output would then be Thing1+Thing2.
3. The user could then apply numbers to Thing1 and Thing2, and the function would be evaluated to find a numerical output.

### Example 2

a+f(b); is a function of three inputs, where one of them, f, is another function. This is shown in FIG. 4c.

A function could take a scalar input and create a list as an output. This example (written in python) takes a single value input and creates a list:
range(a,a+10)

A function might take a list as an input and create a table as an output using the above function. Functions could be written to take any specific type of data as an input and create the same or a different type of data as an output. Inputs will come from another node.

A function might contain flow control or any other tools used by functional programming languages. For example, this function, using flow control, takes a list and returns a number (using Python as an example again):
Under10Count=0
For i in a:
   If i<10, Under10Count+=1
Output=Under10Count

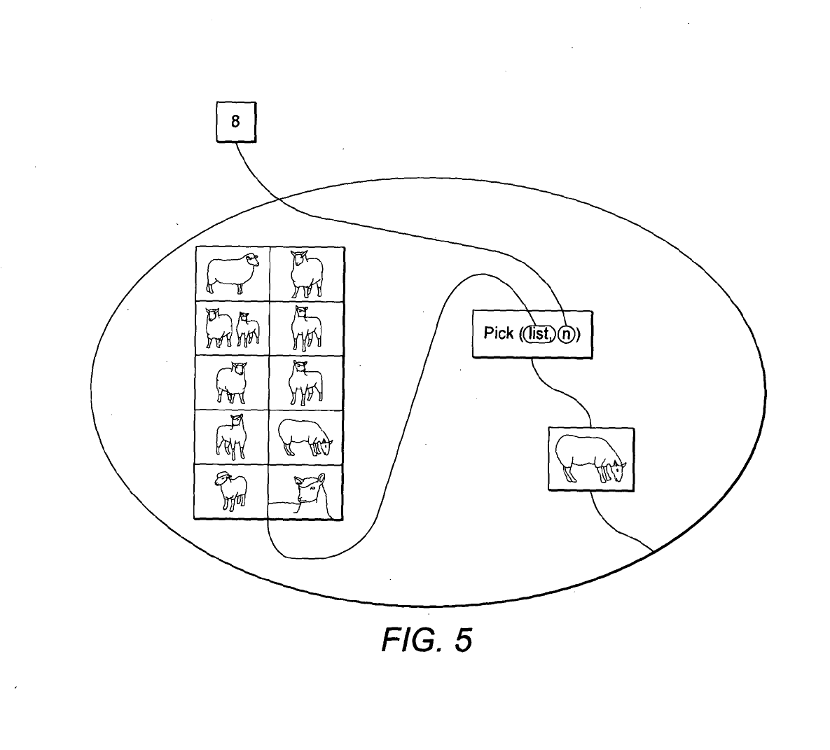

With reference to FIG. 5, let's take a slightly more complex example of a model which receives one type of data and returns another. Say we want the user to choose a number to select from a list of 10 images and we want to return the chosen image. A model fragment, with a list containing 10 images, could packaged as a function. It receives as an input a number between 1 and 10, and returns the image corresponding with that numbered position in the list.

A function could be a call to an external interface.

A function can be passed as an output or received as an input to another node.

For commutative inputs to a function, a group or label-set or list can form an input.

For non-commutative inputs to a function, only a list or single-member output can form an input to it.

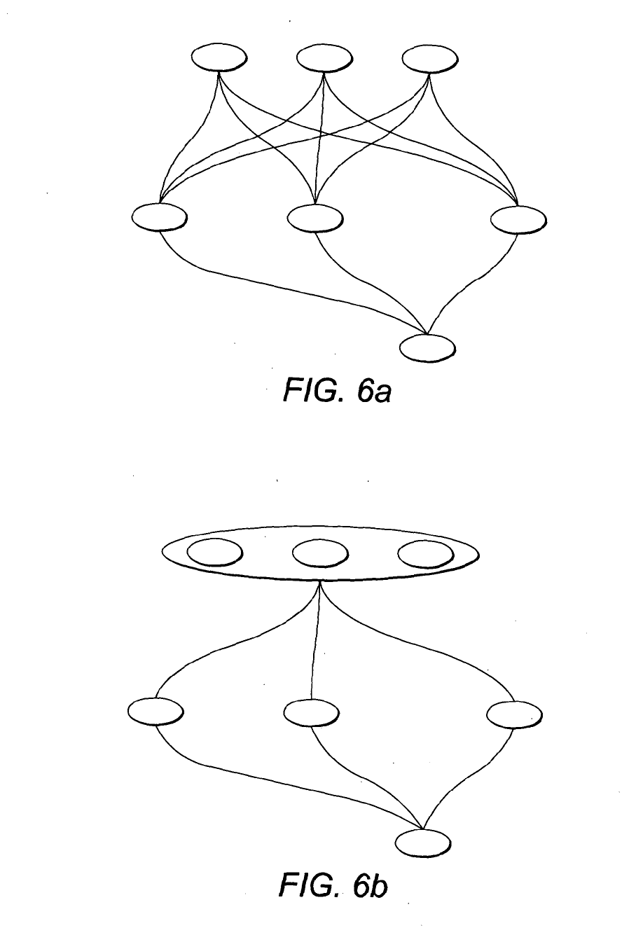

### Complex Inputs

Where inputs become a complex web (FIG. 6a), groups of inputs can be collected together in a label-set (FIG. 6b). This can happen in two situations. 1—when it becomes impossible or unreasonably difficult to show the nodes without crossed lines; or 2—when it becomes difficult to fit all the nodes on the screen and more space is required.

### Tables (and Hypercubes)

A table is defined by a list of ‘dimensions’. Each member of that list is a node with 0 or more dimensions and can lend 0 or more of its dimensions to the table. Each dimension of the table forms a column heading of the table.

For example, we might have a set of monthly events which take place and we want to record a set of things about each individual event.

There are three lists which define this situation.
1. The list of months: January, February, March, April.
2. The list of events: Minibar, Hacker News, Product Tank.
3. List of things we want to know: Cost, no. RSVPs, Turnout.

These three lists become the column headings of a 3 dimensional hypercube.

### 2 Dimensional Example.

### Dimensions List:

Minibar (has 0 dimensions—effectively just a title or label)
VenueCosts (has 2 dimensions but contributing 0 dimensions)
Things we want to know (1 dimension)
Months (1 dimension)

The table would then look like this and the cells could be populated with values by the user:

| Minibar Venue Costs 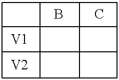 | Jan | Feb | Mar | Apr |
|---|---|---|---|---|
| Cost | | | | |
| No. RSVPs | | | | |
| Turnout | | | | |

Including the ‘Venue Costs’ table as a dimension-contributing-0-dimensions allows the user to access its values from functions written within the cells of the Minibar table.

In a similar way, a table could be included which contributed 1 or more of its dimensions. For example, if there were another table containing information about each month:

| | January | February | March |
|---|---|---|---|
| Average Temp | | | |
| Average rainfall | | | |

This is a two-dimensional table and could be included in the dimensions list contributing just 1 dimension (months) to the Minibar table.

The result would look something like this:

| Minibar Venue Costs 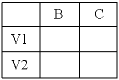 | Jan Temp: Rainfall: | Feb Temp: Rainfall: | Mar Temp: Rainfall: | Apr Temp: Rainfall: |
|---|---|---|---|---|
| Cost | | | | |
| No. RSVPs | | | | |
| Turnout | | | | |

The dimensions which do not contribute to the table's dimensions behave as properties of the column heading, allowing temperature and rainfall to be accessed from table formulae.

The dimension list is ordered.

Members of a table can be populated individually with values (which can be functions).

Functions can also be held outside the table contents in a position which enables them to be generalised to the table contents. A function will be in the 0^{th} dimension or related to a column heading in the xth dimension. Whichever dimension it relates to, it will be applied to every member of each subsequent dimension.

For example:

A function or validation rule can apply to the 0^{th} dimension.
In this case every value in the entire table would be calculated or have the validation rule applied. No other functions or validation rules can exist in the table.

A function or validation rule can apply to a member of the 1^{st} dimension.
In this case it would apply to that member's entry in the 2^{nd} and subsequent dimensions. No other functions or validation rules can apply to positions relating to that member of the 1^{st} dimension.

Etc.

For example, in the Minibar Table (description beneath the table):

| Minibar Venue Costs 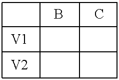 | Jan 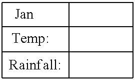 | Feb 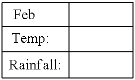 | Mar 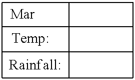 | Apr 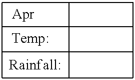 |
|---|---|---|---|---|
| Cost | | | | |
| Function: | | | | |
| ′Venue | | | | |
| Costs′.V1.B | | | | |
| No. RSVPs | | | | |
| Validation: | | | | |
| “value < 100” | | | | |
| Turnout | | | | |
| Function: | | | | |
| Month.′No. | | | | |
| RSVPs′ - | | | | |
| Month.Rainfall | | | | |

In this example Cost and Turnout in Dimension 1 (′Things We Want To Know′) contain formulae. ‘No RSVPs’ contains validation. These apply to all subsequent dimensions (in this case, Dimension 2—Months).

Functions in tables are able to navigate the table to collect information. In every other way, Table content-nodes are identical to other nodes.

A function can refer to and use its column headings or any properties of its column headings.

A function can refer to nodes contained in other positions, at a fixed position, a relative position, or using search criteria.

Tables can be viewed through a pivot-table like mechanism.

### Views and Filters

A node can contain a filter. Such a filter in a node can be applied to any data. This data it is applied to could be the full set of data items in a model, the full set of nodes, or any subset of nodes or data.

Any node can be used as a view definition.

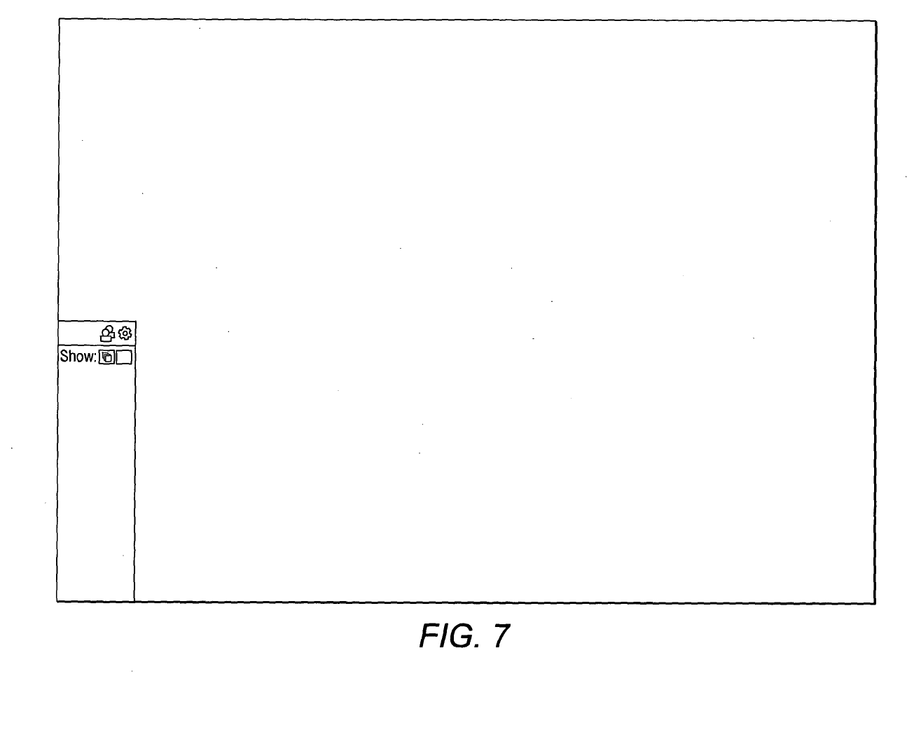

A workspace can have a filter/view area. An example is shown in FIG. 7.

By dragging a node into a filter area, that node becomes the definition of the filter applied to the view in question.

If that node is a filter, the filter will be applied to the entire model (or added to some other default filter) and the result displayed on the screen.

If that node is not a filter, the contents of that node will be displayed.

A filter node can be created by applied the required view to the filter box and then dragging the filter box into the main space.

### Users

Nodes can be people. People-nodes behave the same as other nodes and can be grouped in the same way.

A people node behaves the same as other nodes. It is a compound node containing data, but people nodes can be contained within an address-book node which lives outside any particular model in a separate space owned by individuals, companies or employees. Models are shared by applying filter-nodes to a sharing-rights node (which will specify output-only, read-only, or editable), and then applying that to the people nodes (or a Group containing people-nodes.

People nodes, like other nodes, can have inputs from outside the system. This allows them to be kept up-to-date, for example, by collecting contact details from Facebook or Linkedin. As well as being used for sharing, they can also be used within a model, in the same way as any other node.

### Sharing

Any model, parts of a model, or model fragment can be shared through a link.

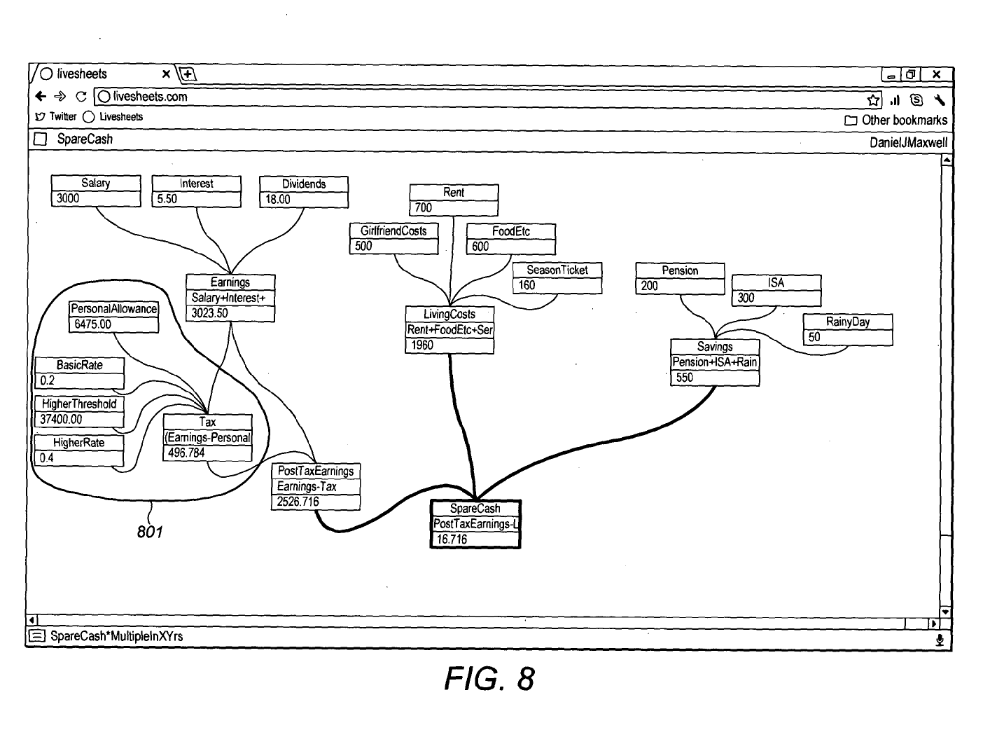

With reference to FIG. 8, an example of a simple model is shown. A user might decide to share the tax section (801) as a model fragment.

They would do this by grouping the circled model-fragment, applying share-rights (such as read-only) and applying it to the users or groups of users they wish to share with. The result would be that the function would be available to the user it is shared with, who could connect any node to the one input which is not contained within the group. The name of that input (shown to the user it is shared with) would be the name used in the function written within the node which receives the input.

Functions for which their full set of inputs have not been connected can output another function. This is similar to the way Lambda functions work except that in this system, inputs can be tied to specific variables within the function, whereas in Lambda functions the inputs are applied in a predefined order.

If the function is shared without read-access, the resulting output function will be executable but not readable.

Sharing could be with specified logged-in users, groups of users or with the internet at large through a plain link or through an obscure link.

Sharing could be through a RESTful interface.

When sharing, each node exposed can be output-only, read-only, or editable.

However it is shared, a shared model could be extended by the outside user. That user could extend in their own ‘space’ (ie not shared with the original creator) or within the original model-space, if they have been given editable access. An extension might be onward calculation, pre-calculation (to calculate inputs) or through labels and annotations.

Models can be recursively shared (i.e. a user could extend a model and share the result).

Sharing will be through obscure links (in which case no authentication is applied) or by dragging users from the contact book (which is held outside the model) or by searching for registered users or by adding users with the model with a usernamegroupname or by adding them with verifiable credentials (such as an email address, OpenID, Facebook username, Twitter name, LinkedIn name, or using any other service which may become available for this purpose).

### Market

A model or model-fragment could be shared through a market. When sharing, the creator could opt whether to share it per-execution, per-time, for a one-off or recurring fee, for a particular version, or with a surcharge over the users' usage costs.

When sharing, the creator can opt whether to provide for the recipient's usage costs or allow usage costs to be passed to the recipient.

### Version Control

Nodes (and models) can have a version numbers.

The version numbers can be tagged with a time/date and name of the user who made the edit.

A reference to another node or model (for example, when shared) can be to a specific version or to whatever is the latest.

### Data Views

Multiple views could be applied to the same model or data.

A data interface will be represented as a node.

A data interface could contain a user-editable application layer which will automate data changes and control what is viewed at any point in time.

In some cases, data interfaces (such as graphs) could be contained within other data interfaces.

Data views will, communicate with the server/calculation engine by sending messages. The User Interface sends five types of messages to the calculation engine:
Create a node
The request will also include the data the node contains, and anything else it knows about the type.
Change a node
Create a connection
Change a connection
Request data

The User interface also listens for messages from the engine. After processing or delegating its request, the engine returns one of five types of messages to the user interface:
Confirmation of a request
Data as requested
Unrequested data update
An instruction as demanded by the application logic layer.
Delegated code to speed up processing.

The engine contains a message interpreter. Depending on the type of message, this will:
Send the instruction to the data store
Set new event triggers if necessary.
eg—if the request introduces a new requirement to cascade-update data

A data view could be a graph, or a video or a way of interacting with data such as might be contained in a computer game.

### Extensibility

Users will be able to plug in and share data, data storage resources, data interfaces (for example to particular types of database or with functionally to collect and interpret or parse data from anywhere on the internet), computation resources, functions, interfaces to external function processing, function sets, programming languages, data interfaces, user interfaces, or any other component, device-native applications, groups of people, or any other part of a model. Any of these could be made available through the market.

### Location-Flexibility

A particular location could be nominated for data storage.

A particular location could be nominated for the calculations be completed.

The user interface can contain an agent which decides where calculations take place so as to maximise the speed. This can depend on nature of the calculation in question relative to the network speed and the processing power available to the client (user interface). For calculations which can easily be performed by the client, they can be performed locally and the results uploaded to the server. For calculations which cannot easily be performed locally, the request can be sent to the server and calculated there, with the results (or a view of them) sent back to the client.

### Default User Interface

Nodes can float freely in the workspace or be fixed in particular positions.

The location is not a fundamental part of the node or its relationship to anything else. So it can be represented as being in whichever position is convenient at the time. This enables the software to draw nodes so as to maintain the simplicity of the relationships between whichever nodes are visible at the time. If required, the user can create a data view, in which they choose to fix nodes in particular positions on the screen or within a canvas. This could be useful if they wanted to prepare a representation of the data for display on a printed page.

Most relationships between nodes can be defined through some form of dragging.

Nodes containing more than one node (a list, label, table, group, embedded document or reference to external data) can be collapsed to show a summarised view, and expanded.

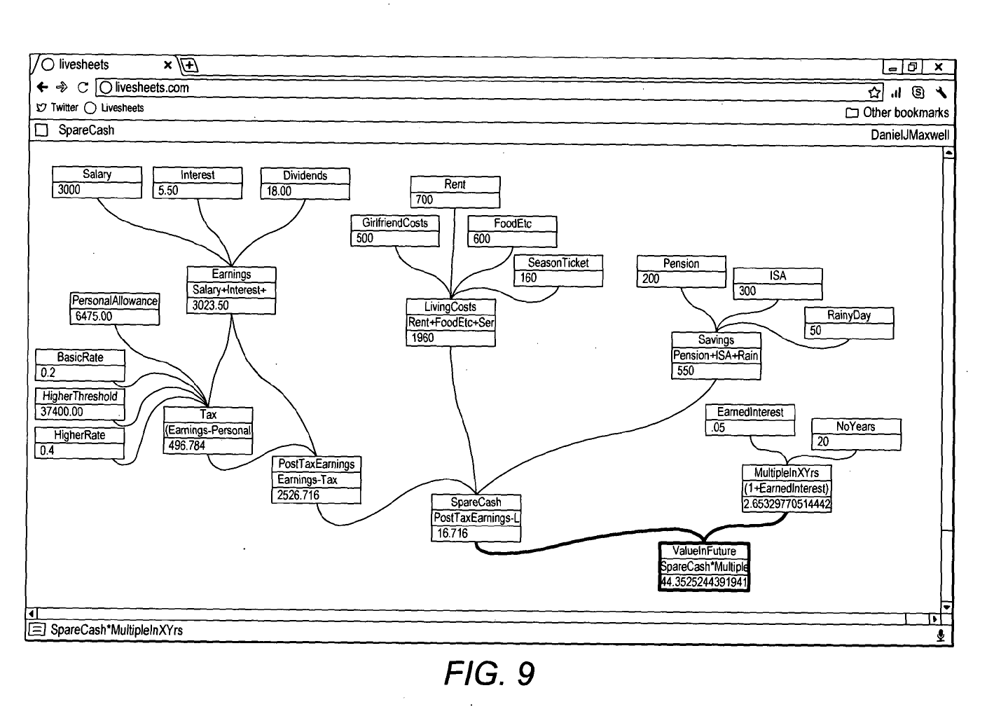

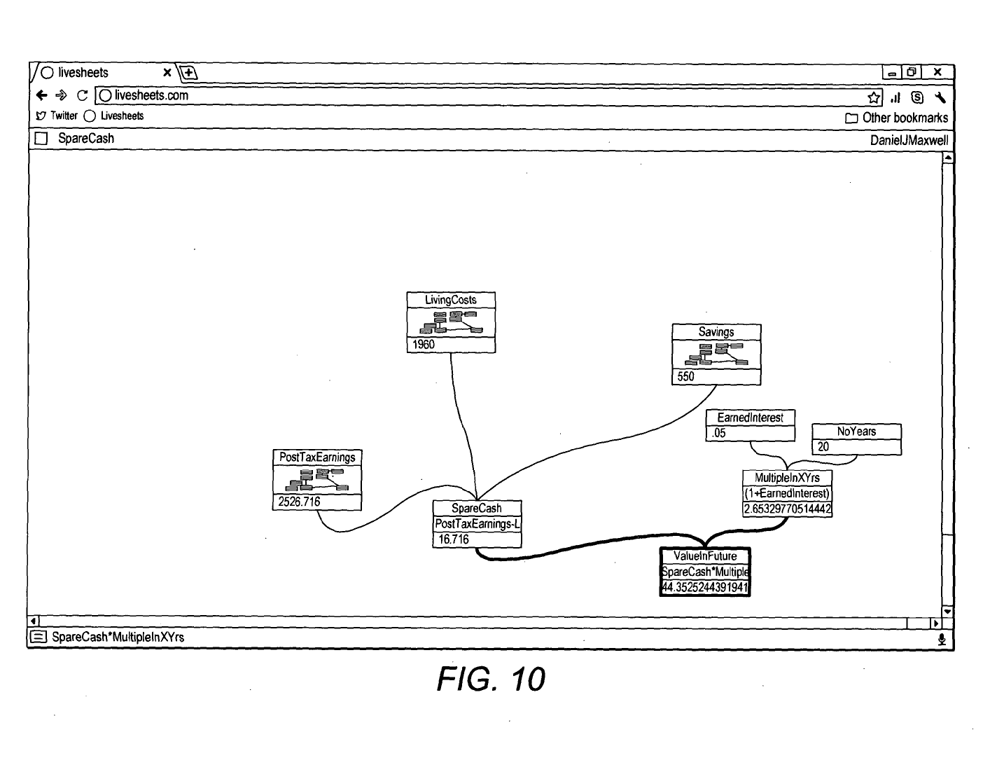

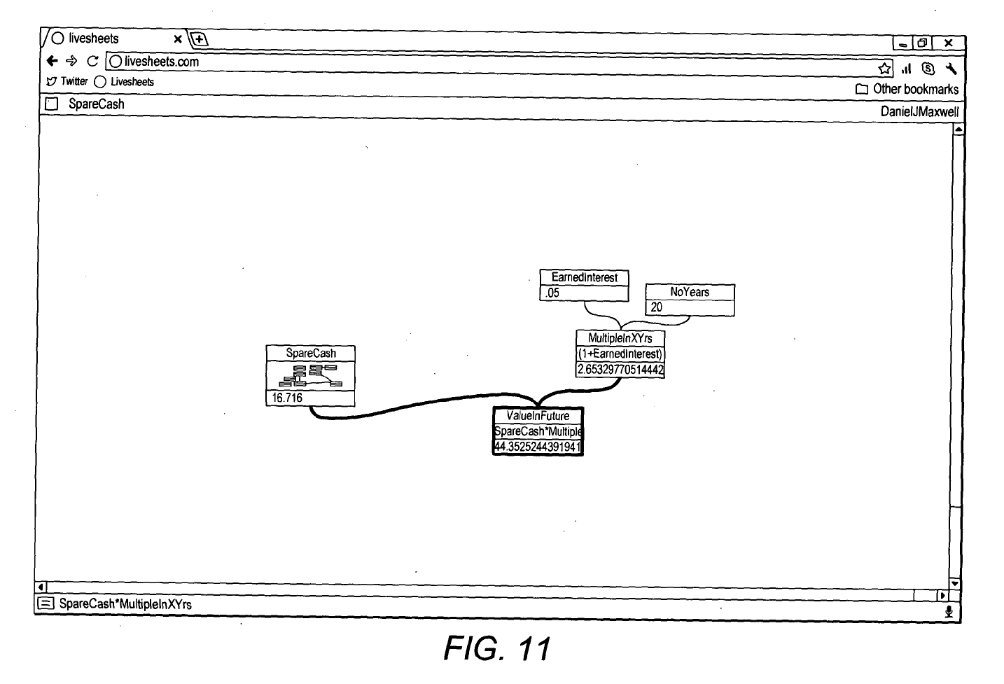

For example, in the model shown in FIG. 9, sections of it could be collapsed to create the views like those shown in FIGS. 10 and 11. The view could be an image which is simply indicative of a collapsed view or could contain something more representative of the actual contents.

Multiple view-sets can be available in the screen such that nodes can be moved between them.

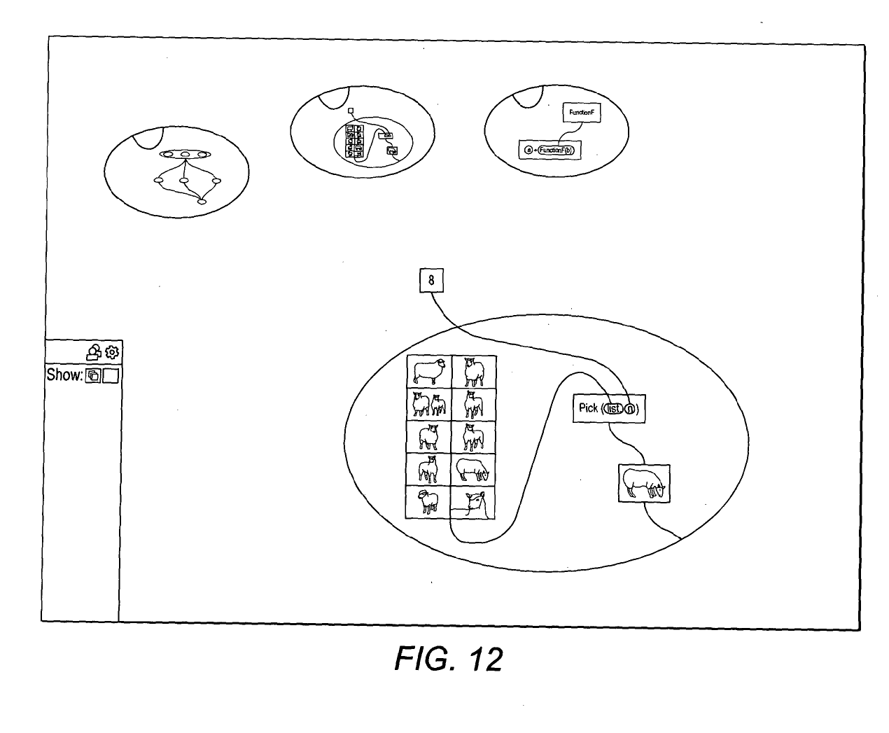

View-set nodes could be visible simultaneously with a particular view in the main space. FIG. 12 shows a simple representation of how this might look.

### Number Formats and Formatting

A number format or text format definition can be contained in a node and applied to other nodes (and will therefore be applied to the display of that node's output.

### Data Architecture

A group definition consists of:
A table in a relational database listing unique identifiers of the nodes it contains and the address at which the definition of each node can be found. Some of those nodes are also groups.
A table of the inbound connections giving the address of each incoming connected node.
A table of the output connections giving the address of each outgoing connected node.

A group is just a type of node and nodes are defined in a similar way. Each one consists of a database table specifying:
The address of the core data it contains (which can be in a file).
A table of the inbound connections giving the address of each incoming connected node.
A table of the output connections giving the address of each outgoing connected node.

A user is a group. The user-type group contains models (which are also groups).

A model is a group containing whatever the user has created within that model.

There is one super-group containing the list of all users.

When a user accesses the site, the system will look up their id in the database table belonging to the super-group and find the location of the user-type group for that user. The user-type group will be queried to find the models-type groups it contains and user interface the user has chosen to use. The relevant user interface will be applied and and the user can then choose which model to open. The model-type group will be queried and its contents delivered to the user interface. The system will need to query each group and node to find its inbound and outbound connections and display them. It will not need to read the full contents of each group unless its needs to be calculated as a function or the user interface chooses to request its contents.

The system comprises a series of software components, all of which interact with an access control component. The access control module simply verifies access rights of the user and passes information between the components.

Instructions to update the model and request data are sent from the user interface to the access control system, which sends them to a module which carries out the instructions. If calculations are requested, it is sent to a calculation module, which calculates the result of the function and returns it back to the access control module to be returned to the user interface. Multiple calculation modules can exist to perform calculations in different programming languages. Not all calculations need to be sent to the server: For smaller calculations, they can be performed more efficiently in the browser or client, with the server simply notified that the calculation has taken place and given the result if applicable.

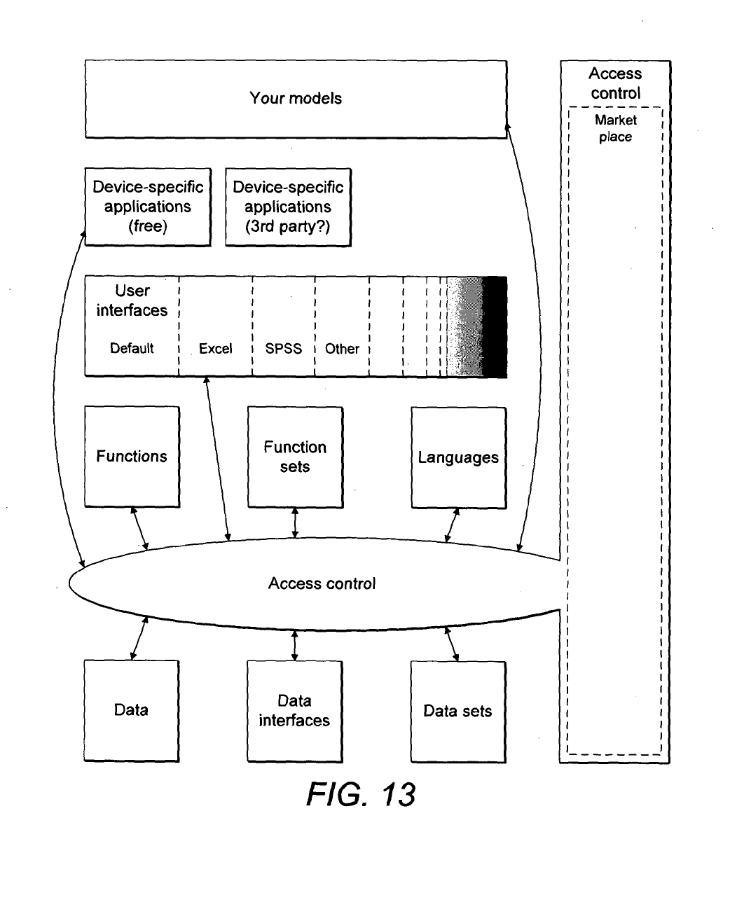

A schematic diagram of the modular structure is shown in FIG. 13.

It will be appreciated that the present invention may be implemented as software executing on computer hardware or within hardware itself.

A potential advantage of some embodiments of the present invention is that as the nodes and connections can be defined visually, a user does not require special training to use the invention. Furthermore, because the invention provides for the user of different types of data formats for each node, complex data structures can be created easily by the user.

Further potential advantages of some embodiments of the present invention is that the system described enables a user to encapsulate and share a model or model fragment with other users such that they can control access rights on a node-level. This means they can share or sell their work to others in a controllable way. For example, it would allow them to share their work with specific users for a specific period of time without divulging the underlying logic. Alternatively, it enables them to sell it to people on a market place and sell their work, charging per access time (eg per day), per-use, or based on the data usage or computing time required. This could apply to any model fragment. A model fragment could be a function, a set of functions, a data type, a formatting definition, a set of data, a data view, or a full user interface. It also enables a market place through which people can sell computer processing time, data storage, modules for accessing external data, and device-specific applications for accessing the system.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A computer-implemented method of managing data, including:
a) defining a plurality of nodes, at least some of the node including different data structures;
b) defining connections between each of the nodes to one or more of the other nodes to form a network of nodes and a data and function flow within the network, wherein each connection defines an output from one node and an input to at least one other node;
c) defining data within at least some of the nodes in accordance with their data structure;
d) defining a function for at least one node of the plurality of nodes, wherein the function defines a processing mechanism for data from one or more of the nodes connected to the one node or for data to one or more of the nodes connected to the one node; and
e) processing the data within the network of nodes in accordance with the connections and functions within the network of nodes.

2. A method as claimed in claim 1 wherein at least one of the nodes is defined as a group of at least some of the plurality of nodes to form a complex data structure.

3. A method as claimed in claim 2 wherein the complex data structure is one of a list, a table, or a hypercube.

4. A method as claimed in claim 1 wherein the data structures include a literal, a list, a table, and a hypercube.

5. A method as claimed in claim 1 wherein the plurality of nodes and connections are defined within a user interface.

6. A method as claimed in claim 5 wherein the user interface is a graphical user interface and the nodes and connections are defined by using graphical entities.

7. A method as claimed in claim 1 wherein a portion of the network is grouped together to form a node, the input and output connections to the node corresponding to the input and output connections to and from the portion of the network.

8. A method as claimed in claim 7 wherein the portion of the network is grouped together in response to user input via a user interface.

9. A method as claimed in claim 8 wherein access control for other users is defined for the grouped portion by the user.

10. A method as claimed in claim 9 wherein the access control includes one or more from the set of write-access, read-access, and input and/or output access to the inputs into the group and/or outputs of each node in the group.

11. A method as claimed in claim 7 wherein the portion of the network is grouped together automatically.

12. A method as claimed in claim 11 wherein the portion is grouped to assist display of the network on a graphical user interface.

13. A method as claimed in claim 1 wherein the connections to a node define inputs to the function defined within the node and the connections from a node define outputs from the function.

14. A method as claimed in claim 1 further including defining a function within at least one node, wherein the function defines a processing mechanism for data within the nodes connected to the one node.

15. A method as claimed in claim 1 wherein at least one of the nodes is defined as a table or hypercube, the at least one node specifies a list of nodes, and each node within the list of nodes provides at least one dimension to the table or hypercube.

16. A method as claimed in claim 15 wherein a function of a node connected to the table/hypercube node is defined to generate data for at least one of the dimensions of the table/hypercube.

17. A system for managing data, including:
A user interface configured for defining a plurality of nodes, at least some of the node including different data structures; for defining connections between each of the nodes to one or more of the other nodes to form a network of nodes and a data and function flow within the network, wherein each connection defines an output from one node and an input to at least one other node; for defining data within at least some of the nodes in accordance with their data structure; and for defining a function for at least one node of the plurality of nodes, wherein the function defines a processing mechanism for data from one or more of the nodes connected to the one node or for data to one or more of the nodes connected to the one node; and
A processing component configured for processing the data within the network of nodes in accordance with the connections and functions within the network of nodes.

18. A computer program product configured to perform the method of claim 1.

19. A medium configured to store a computer program product of claim 18.

20. A medium configured to store processed data produced by the method of claim 1.

21. A medium configured to store a network of nodes produced by the method of claim 1.
